(19) United States
(12) Patent Application Publication
(10) Pub. No.: US 2026/0215615 A1
(43) Pub. Date: Jul. 30, 2026

(54) BEVERAGE MACHINES AND METHODS OF FORMING BEVERAGES

(71) Applicant: Keurig Green Mountain, Inc., Burlington, MA (US)

(72) Inventors: Carl Gottfried Kammer, Newton, MA (US); Matthew Martin Kenneth Hansen, Cambridge, MA (US); Robert Dana Cassano, Centerville, MA (US)

(73) Assignee: Keurig Green Mountain, Inc., Burlington, MA (US)

(21) Appl. No.: 19/158,268

(22) PCT Filed: Feb. 21, 2024
(86) PCT No.: PCT/US2024/016686

§ 371 Date: Aug. 20, 2025

Related U.S. Application Data
(60) Provisional application No. 63/486,444, filed on Feb. 22, 2023.

(51) Int. Cl. A47J 31/46; A47J 31/44; A47J 31/52

(52) U.S. Cl. CPC A47J 31/461; A47J 31/4403; A47J 31/468; A47J 31/52

(57) ABSTRACT

A beverage making machine may form a cooled beverage by recirculating a beverage and/or cooling the beverage using a heat exchanger. The heat exchanger may include a phase change material (PCM), a fluid, and a thermal element. The heat exchanger may be configured such that heat is transferred from the beverage to the PCM, heat is transferred from the PCM to the fluid, and heat is transferred from the fluid to the thermal element.

### CROSS REFERENCE TO RELATED APPLICATION

This application claims the benefit of U.S. Provisional Application No. 63/486,444, filed Feb. 22, 2023, which is hereby incorporated by reference in its entirety.

### FIELD

This invention relates to beverage making machines, such as coffee brewers that use a liquid to form a coffee beverage.

### BACKGROUND

Beverage making machines that use a liquid, such as water, to form a beverage are well known. For example, U.S. Pat. No. 8,094,998 and US Patent application publication 2017/0307252 disclose systems in which water in a heater tank is forced to flow out of the tank and to a beverage making station or dispensing location by introducing unheated water into the tank.

### SUMMARY

In some embodiments, a beverage making machine may comprise a brew chamber configured to form a beverage and a heat exchanger fluidly coupled to the brew chamber. The heat exchanger may comprise a volume of space containing a phase change material and a first fluid pathway in fluid communication with the brew chamber such that brewed beverage from the brew chamber may be configured to flow through the first fluid pathway, the first fluid pathway passing through the phase change material such that heat may be transferred from the beverage to the phase change material. The heat exchanger may further comprise a second fluid pathway passing through the phase change material, wherein fluid communication between the first fluid pathway and the second fluid pathway may be closed and a thermal element configured to cool the fluid in the second fluid pathway such that heat may be transferred from the phase change material to the fluid.

In some embodiments, a method for operating a beverage making machine may comprise providing a beverage making machine having a heat exchanger, the heat exchanger including a phase change material, a fluid, and a thermal element and combining a liquid with a beverage ingredient to form a beverage. The method may further comprise providing the beverage to the heat exchanger and cooling the beverage such that heat is transferred from the beverage to the phase change material, wherein heat from the phase change material may be transferred to the fluid, and wherein heat from the fluid may be transferred to the thermal element.

In some embodiments, a beverage making machine may comprise a brew chamber configured to receive a beverage ingredient and a precursor liquid to form a beverage. The beverage making machine may further comprise a valve fluidly coupled to the brew chamber, wherein the valve may be moveable between a first configuration and a second configuration, wherein while in the first configuration, the valve may be configured to enable recirculation of the beverage such that beverage exiting the brew chamber may be directed to re-enter the brew chamber, and while in the second configuration, the valve may direct the beverage to exit the brew chamber and be dispensed out of the beverage making machine.

In some embodiments, a method for operating a beverage making machine may comprise providing a beverage making machine having a brew chamber and providing a beverage ingredient in the brew chamber. The method may further comprise directing a precursor liquid to enter the brew chamber to combine with the beverage ingredient for a first period of time to form a beverage and recirculating the beverage to further combine with the beverage ingredient for a second period of time.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows an isometric view of a beverage making machine according to some embodiments;

FIG. 2 shows a side view of a beverage making machine according to some embodiments;

FIG. 3 shows a schematic diagram of an illustrative flow circuit in a beverage making machine according to some embodiments;

FIG. 4 shows a heat exchanger according to some embodiments;

FIG. 5 shows another schematic diagram of an illustrative flow circuit in a beverage making machine according to some embodiments;

FIG. 6A shows yet another schematic diagram of an illustrative flow circuit in a beverage making machine according to some embodiments;

FIG. 6B shows a further schematic diagram of an illustrative flow circuit in a beverage making machine according to some embodiments;

FIG. 7 shows an even further schematic diagram of an illustrative flow circuit in a beverage making machine according to some embodiments; and

FIG. 8 shows yet an even further schematic diagram of an illustrative flow circuit in a beverage making machine according to some embodiments.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

Some beverages may involve heating as a step in forming the beverage. For example, a precursor liquid such as water may be heated prior to being combined with a beverage ingredient such as coffee. In some embodiments, the beverages may be consumed while relatively hot. In other embodiments, it may be desirable to consume the beverage while the beverage is relatively cooler, e.g. in “cold brew” and/or “iced” form. Accordingly, the beverage may be cooled prior to being consumed. Cooling a beverage may include introducing cold material to the beverage (e.g., ice), however this presents the opportunity for the beverage to become diluted with the cold material. For example, a beverage may be provided with ice to cool the beverage, heat may be transferred from the beverage to the ice, causing the ice to melt into water, which in turn mixes with and dilutes the beverage. A diluted beverage may have an undesired taste and/or texture, and accordingly reducing or eliminating dilution of the beverage is desired. The inventors have recognized the desire to form cooled beverages while reducing or eliminating dilution of the beverage.

In some embodiments, the heater comprises any appropriate type of heater, boiler, or heat exchanger. For example, in some embodiments, the heater may be a flow-through heater that has a relatively small volume, e.g., a tube with associated heating element to heat liquid in the tube. Examples of flow-through heaters include a flat flow through heater, a spiral flow through heater, a U-shaped flow through heater, or any other type of heater. In some embodiments, the heater may be a heating element that heats a heater tank. The heater may be in thermal communication with the heater tank, e.g. inside the heater tank in direct contact with the water or other precursor liquid inside the tank, or in a non-contact arrangement in which the heater is provided outside the tank or embedded within the tank wall. The heater may be in electrical communication with a controller and/or a user interface. Liquid may enter the heater tank and remain within the heater tank for some period of time, during which the liquid is heated.

In some embodiments, the heater tank may include a sensor configured to sense the temperature of the liquid within the heater tank. In some embodiments, liquid may exit the heater tank after a period of time has lapsed, and/or after a sensed temperature of the liquid is above a temperature threshold.

To form a cooled beverage, heat may be transferred away from the beverage. In some embodiments, a machine may be configured to transfer heat from a beverage. The systems and methods disclosed herein may be used anywhere and for any appropriate purpose, including at home, commercially, industrially (e.g., large scale production of beverages). The machine may be used to make any appropriate beverage including coffee (e.g., iced coffee), tea (e.g., iced tea), mineral and/or vitamin infused drink, or any other appropriate beverage.

The inventors have recognized that a strategy for forming a cooled beverage may include transferring heat from a beverage using a heat exchanger prior to dispensing the beverage. A heat exchanger may enable cooling of liquids without diluting the liquid. In some embodiments, the heat exchanger may include a phase change material (PCM) configured such that heat is transferred from the beverage to the PCM. Further, the heat exchanger may include a fluid configured such that heat is transferred from the PCM to the fluid. The fluid may be cooled using a thermal element such that heat is transferred from the fluid to the thermal element. In some embodiments, the period of time the beverage is cooled by a heat exchanger may be selectively controlled. Increasing the amount of time the beverage is cooled by the heat exchanger may result in a cooler beverage, and decreasing the time the beverage is cooled by the heat exchanger may result in a relatively warmer beverage (although the beverage may still be cool). In other words, the longer the beverage is cooled by the heat exchanger, the cooler the beverage may be.

The inventors have recognized that a strategy for forming a cooled beverage may also include brewing a beverage at a reduced heat (e.g., providing precursor liquid to a brew chamber at a reduced temperature). Brewing beverages at a reduced heat may result in less beverage ingredient being combined with the precursor liquid, which may create a beverage with a weaker or otherwise undesired taste. The Inventors have recognized that recirculating the beverage (e.g., directing brewed beverage exiting the brew chamber to re-enter the brew chamber) to further combine the beverage with the beverage ingredient may help to reduce or avoid the negative effects associated with brewing at a reduced heat. In other words, recirculating the beverage may create a stronger tasting beverage while brewing at a reduced heat.

Recirculating the beverage may include directing the beverage to exit the brew chamber, directing the beverage to re-enter the brew chamber to re-combine the beverage with the beverage ingredient. Recirculating may increase the time the liquid/beverage is exposed to the beverage ingredient. In some embodiments, a valve may be configured to enable recirculation of the brewed beverage into the brew chamber. The valve may be moveable between a first configuration and a second configuration. While in the first configuration, the valve may be configured to recirculate the beverage such that the beverage is directed to exit the brew chamber and enter the brew chamber, and while in the second configuration, the valve may direct the beverage to exit the brew chamber and be dispensed out of the beverage making machine.

In some embodiments, a beverage making machine may utilize both a heat exchanger and recirculation to form a cooled beverage.

In some embodiments, the period of time the beverage is recirculated may be selectively controlled. Increasing the recirculation time may result in a stronger tasting beverage (e.g., more beverage ingredient combined with the liquid/beverage) and decreasing the recirculation time may result in a weaker tasting beverage (e.g., less beverage ingredient combined with the liquid/beverage). In some embodiments, there may be a correlation between the temperature of the precursor liquid and the time recirculating the beverage. For example, decreasing the temperature of the precursor liquid may be associated with recirculating the beverage for an increased time. In some embodiments, the temperature of the beverage during recirculation may decrease.

As described herein, one or more thermal elements may be used to transfer heat associated with the beverage making machine and/or heat exchanger. In some embodiments, a thermal electric cooler (TEC) may be used as a thermal element. TECs (sometimes referred to as Peltier coolers, Peltier heaters, solid state refrigerators, or thermoelectric heat pumps) serve to transfer heat using the Peltier effect. In some embodiments, a TEC may comprise two sides and may be configured to have current (e.g., DC electric current) flow through the device, wherein the flow of current transfers heat from one side to the other. Accordingly, upon activating the device (e.g., flowing current through the device) the side configured to lose heat gets cooler and the side configured to gain heat gets hotter, creating a “cold” side and a “hot” side. In some embodiments, the hot side may be coupled to a heat sink including any appropriate heat transferring elements, including, but not limited to, one or more radiators and/or fans. In some embodiments, the direction and quantity of heat transferred from the cold side to the hot side may be selectively changed by controlling the direction and quantity of current applied to the TEC.

In some embodiments, phase change material (PCM) may be used in the beverage making machine described herein, PCM is a substance that can be used to release or absorb thermal energy at phase transition. In some embodiments, PCM may be associated with a heat exchanger. For example, PCM may be disposed within a volume of space (e.g., internal volume) of a heat exchanger and may be configured to absorb heat from any appropriate material (e.g., fluid) associated with the heat exchanger. PCMs include any substance that can be used to release or absorb thermal energy, including, but not limited to, organic, inorganic, and eutectic PCMs. Examples of organic PCMs include, but are not limited to, hydrocarbons such as alkanes (e.g., paraffins), alcohols, fatty acids, and esters. Examples of inorganic PCMs include, but are not limited to, salt hydrates, nitrates, and metallics. Eutectic PCMs include combinations of organic and inorganic PCMs in any suitable arrangement. In some embodiments, water may be used as a PCM. In some embodiments, paraffin wax may be used as a PCM.

In some embodiments, a PCM may have a transition temperature range between −20° C. and 40° C. and a latent heat of fusion range between 20 Joules per gram and 340 Joules per gram. While these ranges of transition temperatures and latent heat of fusion for a PCM are disclosed, a PCM may have any suitable transition temperature and latent heat of fusion as the disclosure is not limited in this regard. In some embodiments, a PCM may have a transition temperature that is greater than or equal to −20° C., −10° C., 0° C., 10° C., 11° C., 12° C., 13° C., 14° C., 15° C., 16° C., 17° C., 18° C., 19° C., 20° C., 21° C., 22° C., 23° C., 24° C., 25° C., 30° C., 40° C. In some embodiments, a PCM may have a transition temperature that is less than or equal to 40° C. 30° C., 25° C. 24° C., 23° C., 22° C., 21° C., 20° C., 19° C., 18° C., 17° C., 16° C. 15° C. 10° C., 0° C., −5° C., −10° C., or −20° C. In some embodiments, combinations of the above-referenced ranges are also possible. For example, in some embodiments, a PCM may have a transition temperature of −20 to 40° C., −10 to 35° C., 0 to 30° C., 10 to 25° C., 12 to 23° C., 14 to 21° C., or 17 to 19° C., inclusive.

In some embodiments, a PCM may have a latent heat of fusion that is greater than or equal to 20 Joules per gram, 50 Joules per gram, 100 Joules per gram, 150 Joules per gram, 160 Joules per gram, 170 Joules per gram, 180 Joules per gram, 190 Joules per gram, 200 Joules per gram, 210 Joules per gram, 220 Joules per gram, 230 Joules per gram, 240 Joules per gram, 250 Joules per gram, 300 Joules per gram, 400 Joules per gram, or 500 Joules. In some embodiments, a PCM may have a latent heat of fusion that is less than or equal to 500 Joules per gram, 400 Joules per gram, 300 Joules per gram, 250 Joules per gram, 240 Joules per gram, 230 Joules per gram, 220 Joules per gram, 210 Joules per gram, 200 Joules per gram, 190 Joules per gram, 180 Joules per gram, 170 Joules per gram, 160 Joules per gram, 150 Joules per gram, 100 Joules per gram, 50 Joules per gram, or 20 Joules per gram. In some embodiments, combinations of the above-referenced ranges are also possible. For example, in some embodiments, a PCM may have a transition temperature of 20 to 400 Joules per gram, 50 to 300 Joules per gram, 100 to 250 Joules per gram, 150 to 240 Joules per gram, 160 to 240 Joules per gram, 170 to 230 Joules per gram, or 180 to 220 Joules per gram, inclusive.

Sensors may be used to sense parameters associated with one or more liquids associated with a beverage making machine. For example, a sensor may sense a temperature, pressure, volume, level, flow rate, conductivity, salinity, turbidity, and/or any other appropriate parameter associated with a liquid. Accordingly, any appropriate sensors may be used herein. For example, the beverage making machine may include any appropriate combination of temperature sensors, pressure sensors, volume sensors, level sensors, flow rate sensors, and/or any other appropriate type of sensor. In some embodiments, a conductive probe may be arranged to contact liquid in a liquid supply line, tank, valve, or any other appropriate element e.g., to detect a presence or absence of liquid.

In some embodiments, a sensor component may include at least one conductive element that contacts a liquid to detect the presence or absence of liquid, and a temperature component to detect temperature, and may be arranged in different ways and/or to detect other physical characteristics of the liquid. For example, a sensor can include a sensor arrangement to detect pressure, conductivity, salinity, turbidity and/or other characteristic of the liquid, etc. In some embodiments, the sensor can detect three or more characteristics of the liquid, such as temperature, conductivity, and presence/absence.

In some embodiments, a beverage making machine may be used to form a beverage by combining a beverage precursor liquid with a beverage ingredient. The beverage making machine may allow a user to prepare a small quantity of a beverage such as a single serving or a small batch of beverage. Multiple users can use the same machine to prepare different beverages, such as individual servings of different beverage types or beverage flavors quickly and without wasting unconsumed beverage.

In some embodiments, the beverage making machine may be used with a beverage pod to form a beverage such as tea, coffee, espresso, cocoa or other infusion type beverages, The beverage pod may include beverage ingredients such as suitably prepared coffee beans, tea leaves, etc. The beverage making machine may form such beverages using a beverage precursor liquid, such as water, that may be combined with the beverage ingredients of the beverage pod under suitable conditions to form the beverage.

In some embodiments, the beverage machine may be used with package-less beverage pods. The package-less beverage pod may be able to hold its own shape, and thus may not require individual packaging to prevent dispersing of the beverage ingredients prior to use in forming a beverage. Such beverage pods may, for example, be in the form of a compacted tablet or a capsule (which may or may not be made of compacted materials), The beverage ingredients may be contained without separate, removable packaging. In some embodiments, the beverage ingredients of the package-less beverage pod have been compacted. In some embodiments, the package-less beverage pod may be bound together with a food-grade binder or with another beverage ingredient that promotes formation of the beverage tablet into a cohesive structure. Some package-less beverage pods may be formed through processing alone, such as by pressing, heating, or drying into the desired form.

In some embodiments, the package-less beverage pod may include a shell, such as a coating, disposed along the outer surface at the periphery of the pod. In some embodiments, the shell may bind the beverage ingredients within the interior of the pod. The beverage ingredients within the pod may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. Material of the package-less beverage pod, including a shell of the pod if one is present, may directly contact some portion of the beverage machine, such as the brew chamber, before brewing the beverage, without intervening packaging in-between.

The package-less beverage pod may be configured to break into pieces during brewing or it may be configured to remain intact during brewing. The package-less beverage pod may be configured to at least partially or completely dissolve. In some embodiments, the package-less beverage pod may contain roasted coffee grounds (e.g. that remain behind after forming a beverage), soluble coffee, soluble materials, binders or other materials, and any combination of the above. The package-less beverage pod may be any suitable shape, such as a cylinder, a sphere, an ellipsoid, an elliptical prism, a teardrop shape, a frustrum of a cone, a cone or other shape.

In other embodiments, however, the beverage pod may be an individually packaged serving of beverage ingredients. The individual package of beverage ingredients may be removed from the beverage making machine and discarded after the beverage has been prepared. In some embodiments, at least a portion of or the entire packaging may be made of an edible, soluble, biodegradable, recyclable and/or compostable (e.g. home compostable and/or industrially compostable) material, or any combination thereof.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

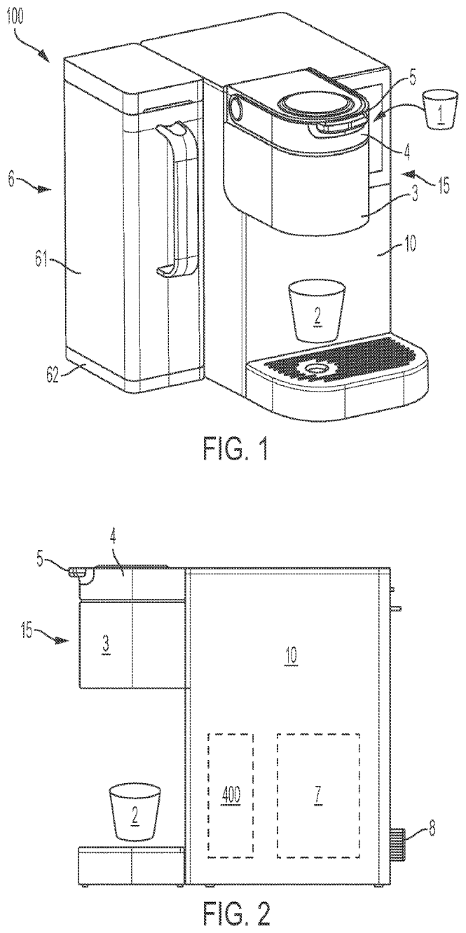

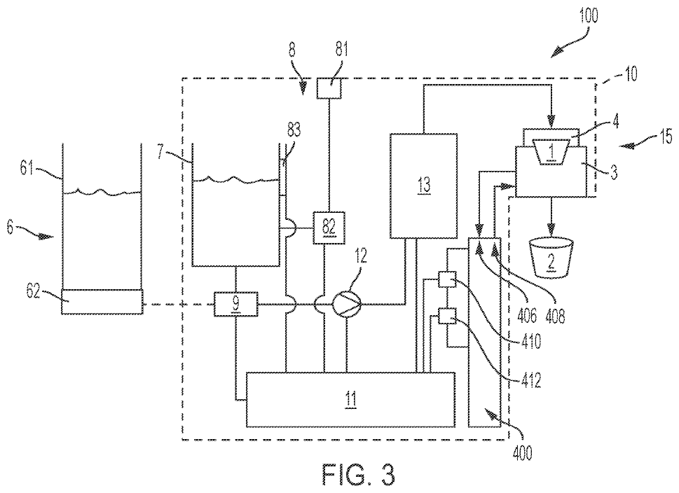

FIG. 1 shows a perspective view of a beverage making machine 100, e.g., a beverage making machine, that incorporates various features of the disclosure. Although the beverage making machine 100 may be used to form any suitable beverage, such as tea, coffee, other infusion-type beverages, beverages formed from a liquid or powdered concentrate, soups, juices or other beverages made from dried materials, carbonated or uncarbonated beverages, or other, in this illustrative embodiment, the machine 100 is arranged to form coffee beverages. In some embodiments, a beverage pod 1 may be provided to the machine 100 and used to form a beverage that is dispensed into a user's cup or other suitable container 2. The pod 1 may be manually or automatically placed in a brew chamber 15 that can include a pod holder 3 and cover 4. For example, the pod holder 3 may include a cup-shaped or otherwise suitably shaped opening in which the pod 1 may be placed, With a pod 1 placed in the pod holder 3, a handle 5 may be moved (e.g., downwardly) so as to move the cover 4 to a closed position (as shown in FIG. 1). In the closed position, the cover 4 may at least partially cover the pod 1, e.g., so the pod is at least partially enclosed in the brew chamber 15. Water or other liquid may be provided to the pod 1 (e.g., by injecting the liquid into the pod interior) to form a beverage that exits the pod 1 and is provided via a beverage outlet to a cup 2 or other container. As can be seen in FIGS. 1 and 2 for example, liquid may be provided to a brew chamber 15 or other dispensing station from an external reservoir 6 and/or an internal reservoir 7. The reservoirs 6, 7 may be provided with liquid from a mains water connection 8 which allows the machine 100 to be connected to a plumbed water source and/or by a user, e.g., by pouring the liquid into the external reservoir 6 and/or through an opening in the beverage making machine housing 10 into the internal reservoir 7. In some embodiments, the external reservoir 6 can include a tank 61 which is removable from a tank base 62, e.g., to allow the tank 61 to be more easily filled with water. The tank base 62 may additionally be removable from the housing 10 if the external reservoir 6 is not used.

The machine 100 shown in FIGS. 1 and 2 is only one example of a beverage making machine that can incorporate inventive features described herein. Thus, inventive features may be employed with any suitably arranged machine 100, including drip-type coffee brewers, espresso-type coffee machines, carbonated beverage making machines, and other systems that dispense a beverage. Such systems need not necessarily use a pod, but instead the brew chamber or other dispensing station may accept ground coffee (e.g., in loose form) or other beverage material in other ways to make a beverage. Also, the brew chamber 15 need not necessarily include a pod holder 3 and a cover 4. For example, the brew chamber may include a filter basket or other receptacle arranged to receive beverage material and to combine the beverage material with water or other liquid to form a beverage. In some embodiments, the brew chamber need not be user accessible, but instead beverage material may be automatically provided to, and/or removed from, the brew chamber. Moreover, the machine 100 need not have a brew chamber 15, but instead other types of dispensing stations, e.g., that dispense hot and/or cold water or other liquid (whether still or carbonated) at a beverage outlet such as a dispensing nozzle without mixing with any beverage ingredient. Accordingly, a wide variety of different types and configurations of beverage making machines may be employed with inventive features.

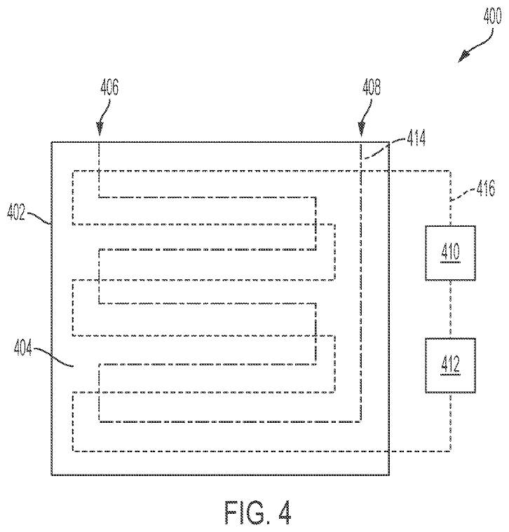

FIG. 3 shows a schematic diagram of a liquid supply and other components of an illustrative beverage making machine 100 for forming a beverage. As noted above, the liquid supply of the machine 100 may include an external reservoir 6 and/or an internal reservoir 7, e.g., including a mains water connection 8 having a connector 81 to fluidly connect to mains water, a mains valve 82 that controls flow to the internal reservoir 7 and a level sensor 83 to detect a liquid level in the internal reservoir 7. The mains valve 82 can be controlled by a controller or control circuitry 11 based on information from the liquid level sensor 83, e.g., the mains valve 82 can be operated to establish a desired water level in the internal reservoir 7. A distribution valve 9 can selectively couple either of the reservoirs 6, 7 to the brew chamber 15 or other dispensing station for delivery of liquid. The distribution valve 9 may be controllable, such as manually by a user or electronically by the controller 11, to select between the external reservoir 6 and internal reservoir 7. Beverage parameters may be set by default by the controller 11, by a user interacting with a user interface, and/or by reading a machine readable feature on a pod 1 and using corresponding parameters.

A pump 12 may deliver liquid from the valve 9 to a heater 13 or other liquid conditioning device, e.g., to heat, carbonate, or otherwise condition water or other liquid for forming a beverage. Employing a pump 12 may allow the machine 100 to vary a flow rate and/or pressure of the liquid as desired, e.g., to form espresso-type or other beverages using higher pressure liquid as well as drip-type coffee or other beverages made using lower pressure liquid. In some embodiments, pumping of water or other liquid into the heater 13 causes heated liquid to flow to the brew chamber 15 for mixing with a beverage medium (or not) and for dispensing as a beverage,

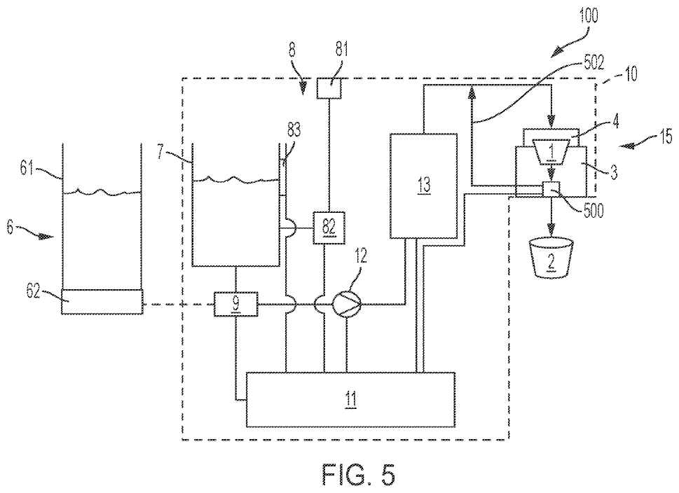

A heat exchanger 400 may be fluidly coupled to the brew chamber 15 and fluid (e.g., brewed beverage) from the brew chamber may be directed to an inlet 406 of the heat exchanger 400. As shown in FIG. 4, the beverage may move through a first fluid pathway 414 disposed within an internal volume 404 of the heat exchanger 400. The first fluid pathway 414 may be fluidly coupled to the inlet 406 and an outlet 408 of the heat exchanger 400. A PCM may be disposed within the internal volume 404 and configured to cool the beverage such that heat is transferred from the beverage moving through the first fluid pathway 414 to the PCM. The cooled beverage may move through the outlet 408 to the brew chamber 15 and may be dispensed.

The PCM may be in a transition state. Accordingly, upon heat being transferred to the PCM (e.g., from beverage in the first fluid pathway), the PCM may transition states. For example, the PCM may transition from a solid to a liquid upon heat being transferred from the beverage to the PCM. In another example, the PCM may transition from a liquid to a gas upon heat being transferred from the beverage to the PCM. However, the PCM need not necessarily transition states as the disclosure is not so limited. For example, heat may be transferred from the beverage to the PCM without the PCM changing states.

The heat exchanger 400 may also include a second fluid pathway 416 fluidly coupled to a pump 412. The pump 412 may move a fluid, such as a refrigerant, coolant, or any other appropriate type of fluid, through the second fluid pathway 416. The second fluid pathway 416 may be configured such that heat is transferred from the PCM to the fluid in the second fluid pathway. The heat exchanger may also include a thermal element 412 configured such that heat is transferred from the fluid in the second fluid pathway 416 to the thermal element 412. The thermal element 412 may optionally be fluidly coupled to the second fluid pathway 416. In some embodiments, the thermal element 412 may be a TEC. Heat may be transferred from the fluid in the second fluid pathway 416 to the TEC upon activating the TEC. As previously described, activating the TEC may involve flowing current through the TEC. The thermal element 410 and pump 412 may be coupled to the controller 11 and the controller 11 may be used to control the thermal element 410 and the pump 412. As such, the controller 11 may activate and deactivate the thermal element 410. It should be appreciated that the first fluid pathway 414 and the second fluid pathway 416 may be formed in any appropriate arrangement, pattern, or layout. For example, the depicted first fluid pathway 414 and second fluid pathway may include tubes/pipes inside of which the liquid/fluid travels and the tubes/pipes may be arranged in any appropriate manner as the disclosure is not so limited. The first and second fluid pathways may be separate and distinct pathways such that fluid communication between the first fluid pathway and the second fluid pathway is closed.

The quantity of heat transferred from the fluid may be selectively controlled by the controller 11. For example, in some embodiments, the temperature of the beverage exiting the heat exchanger could be a cold beverage (e.g., 32° F. to 50° F.), or an ambient temperature (e.g., 60° F. to 80° F.). It should be appreciated that the thermal element may be controlled such that the temperature of the beverage may be of any appropriate range as the disclosure is not so limited. In some embodiments, a beverage machine is able to achieve both cold temperature beverages and ambient temperature beverages, depending on a desired outcome, The desired outcome may depend on, e.g., user preferences, user inputs, a sensed beverage pod type and associated brew recipe, etc. In other embodiments, a beverage machine may be capable of producing only either a cold temperature beverage or an ambient temperature beverage.

In some embodiments, the controller may control the thermal element to alter the amount of heat transfer. For example, the controller 11 may cause an increased amount of current flow through the thermal element to increase the amount of heat transferred from the fluid to the thermal element, in turn increasing the amount of heat transferred from the PCM to the fluid, which increases the amount of heat transferred from the beverage to the PCM. Alternatively or in addition, in some embodiments, the controller may cause control the flow rate of the beverage through the heat exchanger depending on the degree of heat transfer desired. For example, the controller may decrease the flow rate if more heat transfer is desired (e.g. a colder beverage), or may increase the flow rate if less heat transfer is desired (e.g. a warmer beverage). In some embodiments, flow rate may be controlled by controlling a pump that moves the beverage through the heat exchanger. In some embodiments, the pump 12 that moves precursor liquid into the brew chamber 15 may also serve to move brewed beverage through the heat exchanger. However, in other embodiments, a distinct, dedicated pump may be used to move brewed beverage through the heat exchanger.

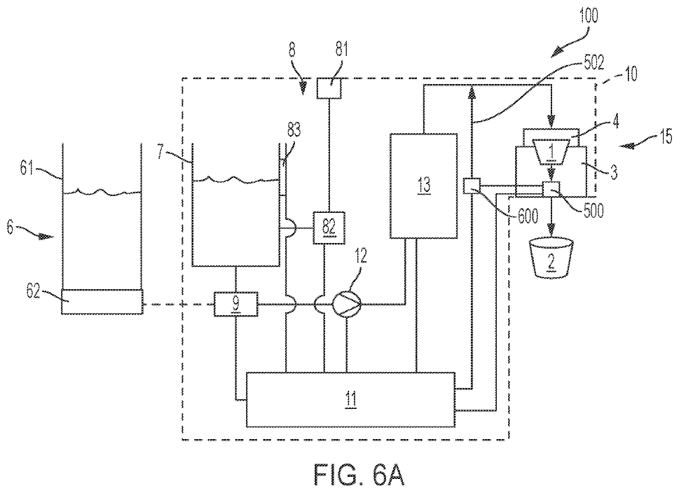

As shown in FIG. 5, a valve 500 may be fluidly coupled to the brew chamber 15 and may be used to recirculate the beverage such that the beverage exiting the brew chamber 15 is directed to re-enter the brew chamber 15 via a recirculation pathway 502. The valve 500 may be coupled to the controller 11 and may be controlled using the controller 11. In some embodiments, the pump 12 may be used to move the brewed beverage through the recirculation pathway 502, although one or more separate pumps may be used as described below. In the depicted embodiment, the beverage exits the brew chamber 15 and moves into recirculation pathway 502, which is fluidly coupled to the brew chamber 15. However, the present disclosure is not limited to a particular arrangement or combination of fluid lines, pathways, pumps, or valves. For example, a plurality of valves may be used to recirculate the beverage with any appropriate arrangement of fluid pathways. The valve 500 may be moveable between a first configuration and a second configuration. In the first configuration, the beverage may be recirculated back into the brew chamber 15 as described above. In the second configuration, the beverage may be dispensed out of the beverage making machine. Optionally, the beverage may be dispensed into a cup 2 or any other appropriate receptacle as the disclosure is not limited in this fashion.

As previously described, recirculating a beverage may allow for brewing the beverage at a reduced temperature. For example, recirculating the beverage may allow for the precursor liquid to enter the brew chamber at a temperature of less than 190° F., less than 180° F., less than 170° F., less than 160° F., less than 150° F., less than 140° F., less than 130° F., less than 120° F., less than 110° F., less than 100° F., less than 90° F., less than 80° F., less than 70° F., less than 60° F., less than 50° F., or ranging from about 32° F. to 50°, 60° F. to 80° F., 60° F. to 90° F., 60° F. to 100° F., 60° F. to 110° F., 60° F. to 120° F., 60° F. to 130° F., 60° F. to 140° F., 60° F. to 150° F., 60° F. to 160° F., 60° F. to 170° F., 60° F. to 180° F., 60° F. to 190° F., or any other suitable temperature.

In some embodiments, recirculating brewed beverage may continue to decrease in temperature during recirculation. In some embodiments, the temperature of the brewed beverage may be lower in subsequent passes through the brew chamber as compared to the first pass through the brew chamber. In some embodiments, the decreasing temperature of the recirculating beverage may be passive (e.g. without input of energy), e.g. due to heat loss to the surrounding ambient environment. Alternatively or in addition, the recirculating beverage may be actively cooled, e.g. through a heat exchanger (such as, but not limited to, the heat exchangers previously described).

In some embodiments, recirculating brewed beverage is not subjected to the same heater that initially heated the precursor liquid (e.g. the recirculation pathway bypasses the heater). In other embodiments, however, the recirculated brewed beverage is sent back to the heater. In some embodiments, the heater may heat the recirculating brewed beverage at a different temperature than the precursor liquid. The heater may heat the recirculating brewed beverage at a lower, higher, or the same temperature as the precursor liquid.

In some embodiments, when a beverage is within a desired range of temperatures, such as those described above, the beverage making machine may stop recirculating the beverage. Further, the beverage making machine may dispense the beverage after recirculation has stopped in some embodiments. In further embodiments, the recirculation may be stopped after recirculation of the beverage has occurred for a predetermined period of time. For example, recirculation may stop after recirculation has occurred for, e.g., 30 seconds to 5 minutes, or any other suitable length of time. In some other embodiments, recirculation may be stopped after the beverage has been recirculated throughout a fluid pathway a predetermined number of instances. For example, recirculation may be stopped after a beverage has exited the brew chamber a number of instances ranging from about 1, 2, 3, 4, 5, 6, 7, 8, 9, 10 instances, or more. In even further embodiments, recirculation may be stopped after a volume of recirculated beverage above a threshold volume is sensed. For example, recirculation may be stopped after a volume of recirculated beverage is sensed ranging from about 2, 4, 6, 8, 10, 12, 14, 16, 18, 20, 22, 24, 26, 28, 30, 32, 40, 48, 56, 64, 72, 80, 88, 96, 100 oz, or more.

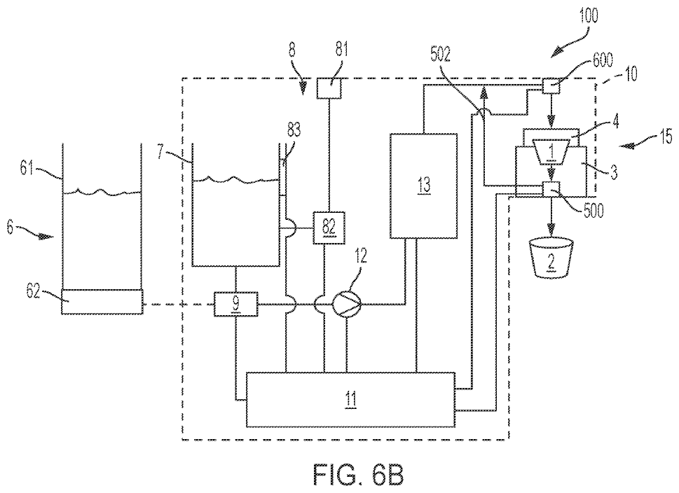

In some embodiments, a designated recirculation pump 600 may be used to recirculate the beverage, as shown in FIG. 6A. Specifically, the pump 600 may cause beverage exiting the brew chamber 15 to re-enter the brew chamber 15. The pump 600 may be coupled to the controller 11 and may be controlled using the controller 11. In the depicted embodiment, the pump 600 is located proximal to the valve 500, although any appropriate placement of the pump 600 is contemplated and the disclosure is not so limited. For example, in the illustrative embodiment of FIG. 6B, the pump 600 may also be located proximal to the brew chamber 15. It should be understood that the embodiments shown in FIGS. 6A and 6B are only examples of possible arrangements and are not limiting. Accordingly, the pump 600 may be located in any appropriate location in the machine 100 to recirculate the beverage.

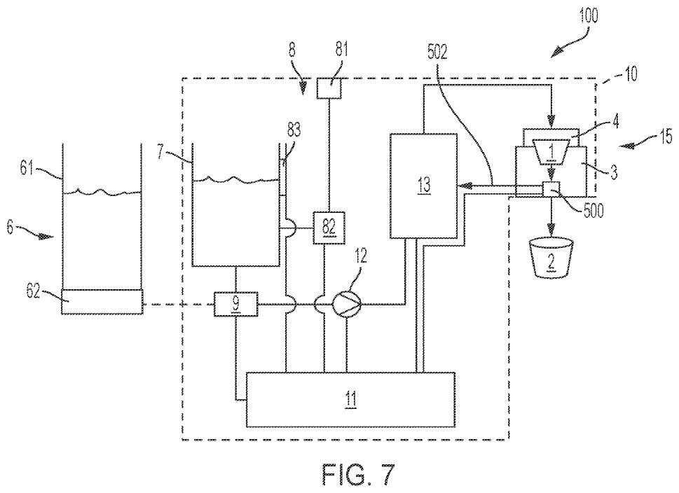

As shown in FIG. 7, the valve 500 may direct brewed beverage exiting the brew chamber 15 to re-enter the heater 13 in some embodiments. The heater 13 may heat the beverage and the beverage may enter the brew chamber 15, thereby allowing the beverage to be heated during recirculation. Heating the beverage during recirculation may be desirable to maintain a temperature or an approximate temperature range during the recirculation, thereby improving the mixing of the beverage and the beverage ingredient and improving the taste or otherwise improving the quality of the resulting beverage. As previously described, the heater 13 may be any appropriate heater or combination of heaters, including a heater tank and/or a flow-through heater.

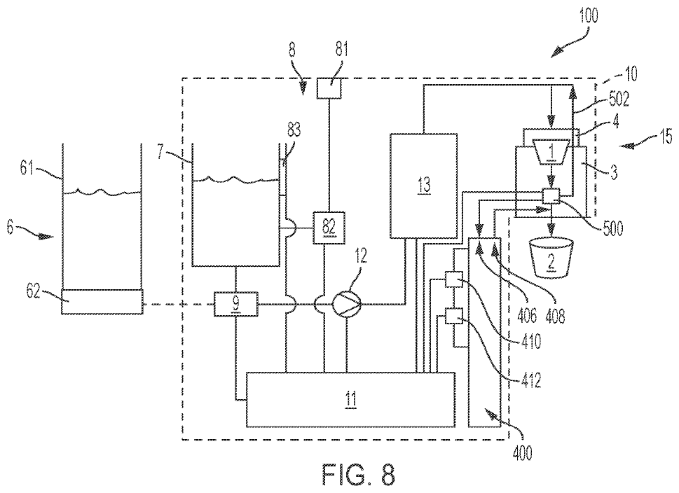

Embodiments including combinations of recirculating and cooling a beverage are also contemplated. As shown in FIG. 8, the machine 100 may include a heat exchanger 400 configured to cool the beverage and a valve 500 configured to recirculate the beverage according to some embodiments. In the depicted embodiment, the valve 500 may be fluidly coupled to the brew chamber 15, an inlet 406 of the heat exchanger 400, and an outlet 408 of the heat exchanger 400. The valve 500 may be moveable between a first configuration, a second configuration, and a third configuration. While the valve 500 is in the first configuration, the beverage may be recirculated such that beverage exiting the brew chamber 15 is directed to re-enter the brew chamber 15. The beverage may also optionally be directed to exit the brew chamber 15 and enter the heater 13 (e.g., while the valve 500 is in the first configuration), as described above with respect to FIG. 7. While the valve 500 is in the second configuration, the valve 500 may be configured to direct the beverage to exit the brew chamber 15 and be dispensed. While the valve 500 is in the third configuration, the valve 500 may be configured to direct the beverage to exit the brew chamber 15 and enter an inlet 406 of the heat exchanger 400. The heat exchanger 400 may cool the beverage as previously described, and the beverage may exit the heat exchanger 400 via an outlet 408. In some embodiments, the beverage may be directed from the outlet 408 such that the beverage may be dispensed.

In some embodiments, beverage exiting the heat exchanger may be sent back to the brew chamber for additional time to combine with a beverage ingredient. As such, in some embodiments, the heat exchanger may be placed in a recirculation pathway.

In some embodiments, a brewed beverage may be recirculated back into a heat exchanger without re-entering a brew chamber. In some embodiments, a beverage machine may have two distinct recirculation pathways: one recirculation pathway for the heat exchanger and one recirculation pathway for the brew chamber. A controller

Embodiments including additional pumps, similar to those described with respect to FIGS. 6A and 6B, in combination with recirculation and cooling a beverage are also contemplated and the disclosure is not limited in this fashion.

The various methods disclosed above may be implemented by one or more controllers including at least one processor operatively coupled to the various controllable portions of a beverage making machine as disclosed herein. Alternatively or additionally, in some embodiments, the disclosed methods may be performed at least in part, and in some instances completely, on a computing device that is separate and removed from the disclosed beverage making machine. In either case, the disclosed methods may be embodied as computer readable instructions stored on non-transitory computer readable memory associated with the at least one processor such that when executed by the at least one processor the associated system, which may be a beverage making machine in some embodiments, may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

The various methods or processes outlined herein may be implemented in any suitable hardware. Additionally, the various methods or processes outlined herein may be implemented in a combination of hardware and of software executable on one or more processors that employ any one of a variety of operating systems or platforms. Examples of such approaches are described above. However, any suitable combination of hardware and software may be employed to realize any of the embodiments discussed herein.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage making machine, comprising:
a brew chamber configured to form a beverage;
a heat exchanger fluidly coupled to the brew chamber, the heat exchanger comprising:
a volume of space containing a phase change material;
a first fluid pathway in fluid communication with the brew chamber such that brewed beverage from the brew chamber is configured to flow through the first fluid pathway, the first fluid pathway passing through the phase change material such that heat is transferred from the beverage to the phase change material;
a second fluid pathway passing through the phase change material, wherein fluid communication between the first fluid pathway and the second fluid pathway is closed; and
a thermal element configured to cool the fluid in the second fluid pathway such that heat is transferred from the phase change material to the fluid.

2. The beverage making machine of claim 1, wherein heat is transferred from the fluid to the thermal element.

3. The beverage making machine of claim 1, wherein the thermal element is a thermal electric cooler.

4. The beverage making machine of claim 1, wherein the brew chamber is configured to hold a beverage ingredient, the brew chamber including an inlet and an outlet, wherein the inlet is configured to permit liquid to enter the brew chamber for combining with the beverage ingredient to form a beverage, and the outlet is configured to allow beverage to exit the brew chamber.

5. The beverage making machine of claim 1, wherein the beverage enters the heat exchanger at a temperature of 170 to 210 degrees Fahrenheit and exits the heat exchanger at a temperature of 32 to 50 degrees Fahrenheit.

6. The beverage making machine of claim 1, wherein the beverage enters the heat exchanger at a temperature of 170 to 210 degrees Fahrenheit and exits the heat exchanger at a temperature of 60 to 90 degrees Fahrenheit.

7. The beverage making machine of claim 1, wherein the phase change material is paraffin wax.

8. The beverage making machine of claim 2, wherein heat is transferred from the fluid to the thermal element upon activating the thermal element.

9. The beverage making machine of claim 8, wherein the thermal element is activated prior to forming the beverage.

10. The beverage making machine of claim 9, further comprising a user interface configured to accept a user input, wherein the user input controls the beverage making machine to activate the thermal element and begin forming the beverage.

11. The beverage making machine of claim 1, further comprising a valve fluidly coupled to the brew chamber, wherein the valve is moveable between a first configuration and a second configuration, wherein while in the first configuration, the valve is configured to recirculate the beverage such that beverage exiting the brew chamber is directed to re-enter the brew chamber, and while in the second configuration, the valve directs the beverage to exit the brew chamber and be dispensed out of the beverage making machine.

12. The beverage making machine of claim 1, further comprising a pump configured to move the fluid through the second fluid pathway.

13. A method for operating a beverage making machine comprising:
providing a beverage making machine having a heat exchanger, the heat exchanger including a phase change material, a fluid, and a thermal element;
combining a liquid with a beverage ingredient to form a beverage;
providing the beverage to the heat exchanger;
cooling the beverage such that heat is transferred from the beverage to the phase change material, wherein heat from the phase change material is transferred to the fluid, and wherein heat from the fluid is transferred to the thermal element.

14. The method of claim 13, wherein the thermal element is a thermal electric cooler.

15. The method of claim 13, further comprising dispensing the beverage out of the beverage making machine.

16. The method of claim 13, wherein prior to transferring heat from the beverage to the phase change material, the temperature of the beverage is about 170 to 210 degrees Fahrenheit, and after transferring heat from the beverage to the phase change material, the temperature of the beverage is 32 to 50 degrees Fahrenheit.

17. The method of claim 13, wherein prior to transferring heat from the beverage to the phase change material, the temperature of the beverage is 170 to 210 degrees Fahrenheit, and after transferring heat from the beverage to the phase change material, the temperature of the beverage is 60 to 90 degrees Fahrenheit.

18-20. (canceled)

21. The method of claim 13, wherein the step of combining a liquid with a beverage ingredient to form a beverage occurs in a brew chamber, further comprising recirculating the beverage comprising:
directing the beverage exiting the brew chamber to re-enter the brew chamber.

22. A beverage making machine comprising:
a brew chamber configured to receive a beverage ingredient and a precursor liquid to form a beverage;
a valve fluidly coupled to the brew chamber, wherein the valve is moveable between a first configuration and a second configuration, wherein while in the first configuration, the valve is configured to enable recirculation of the beverage such that beverage exiting the brew chamber is directed to re-enter the brew chamber, and while in the second configuration, the valve directs the beverage to exit the brew chamber and be dispensed out of the beverage making machine.

23-31. (canceled)

32. A method for operating a beverage making machine comprising:
providing a beverage making machine having a brew chamber;
providing a beverage ingredient in the brew chamber;
directing a precursor liquid to enter the brew chamber to combine with the beverage ingredient for a first period of time to form a beverage; and
recirculating the beverage to further combine with the beverage ingredient for a second period of time.

33-42. (canceled)
